(19) United States
(12) Patent Application Publication
(10) Pub. No.: US 2005/0120070 A1
(43) Pub. Date: Jun. 2, 2005

(54) Method for data exchanging data between a field device and a control device via internet

(76) Inventors: Reinhard Griech, Lorrach (DE); Christian Seiler, Auggen (DE)

Correspondence Address: BACON & THOMAS, PLLC, 625 SLATERS LANE, FOURTH FLOOR, ALEXANDRIA, VA, 22314, US

(21) Appl. No.: 10/498,514

(22) PCT Filed: Dec. 11, 2002
(86) PCT No.: PCT/EP02/14034

(30) Foreign Application Priority Data
Dec. 21, 2001 (DE) 101635656

(51) Int. Cl. G06F 15/16

(52) U.S. Cl. 709/200

(57) ABSTRACT

In a method for data exchange between a field device 1, 2, 3, 4 and a control device 50 via Internet 20, modem 13, 14 and public telephone network 30, the current IP-address of the modem 13, 14 is transmitted to the distributor-server 45 over the public telephone network. Field device queries by the control device 50 to a permanent address of the field device are forwarded via the current IP-address to the field device 1, 2, 3, 4.

The invention relates to a method for exchanging data between a field device and a control device via Internet.

In process control engineering, field devices are in many cases deployed to register and influence process variables. Examples of field devices include temperature measurement devices that record temperature of a process medium, flow-meters that record the flow of a process medium in a pipeline section, or fill level meters that determine the fill level of a liquid or a bulk solid in a container.

In addition to merely transmitting measurements, field devices also allow the transmission of various kinds of information stored in the field device, e.g. parameters (zero point, measurement range, etc.), measurement curves and diagnostic information. The parameters can be adjusted from a control device (configuring and parametering). With every initial installation or with a device exchange, a field device must be configured and parameterized.

Often, access to field devices over larger distances is desired. One possibility is to connect the field device and the control device, each with a modem, over a public communication network. The modem can also be directly integrated in the field device. Alternatively, the field device is not directly connected to the communication network, but, instead, through a gateway. The data transmission occurs e.g. over the public telephone network (analog grid, ISDN, GSM or UMTS). With greater distances, this means, however, telephone costs accumulating as a function of connection time.

An Internet connection is cheaper. With this, the modem on the field device side itself dials over the public telephone network to the nearest Internet-Service Provider. Over the Internet, multiple users can also simultaneously access the field device. The control device, which is either connected with the Internet over a modem or else connected directly with the Internet, can then access the field device data using the appropriate IP-address of the modem. For example the current field device measurement can be queried by the control device via the HTML-page http://195.123.123.123/measurement1.html, where the IP-address of the field device is 195.123.123.123. This only incurs telephone costs for the connection to the nearest Internet-Service-Provider. The disadvantage here is that the IP-address of the modem is not predetermined, but instead is newly assigned by the Internet-Service-Provider from its IP address pool with each dialing instance. This means that, in order to access, the user must change the IP-Address of the field device with each dialing instance. This is undesirable from the point of view of the user.

An object of the invention is, therefore, to provide a method for data exchange between a field device and a control device via the Internet, such that the field device always can be contacted over the same permanent address in a way that is cost-effective and simple to implement.

This object is achieved by a method according to claim 1 or 3.

An essential idea of the invention is that a distributor-server forwards to the current IP-address of the field device, field device inquiries directed to a permanent address. In this way, a specific field device is always contacted via the same permanent address. Since the modem is only occasionally connected to the Internet-Service-Provider, the telephone costs are relatively small.

Advantageous further developments are given in the dependent claims.

In an alternative embodiment, a periodic query of the field device is performed by the distributor-server. The field device data are intermediately stored on the distributor-server. By way of a field device query, the user can retrieve the field device information from the distributor-server.

With this, no delays develop because of having to assemble the connection.

The invention will now be explained in greater detail on the basis of the drawings, whose figure shows multiple field devices connected with a control device via the Internet.

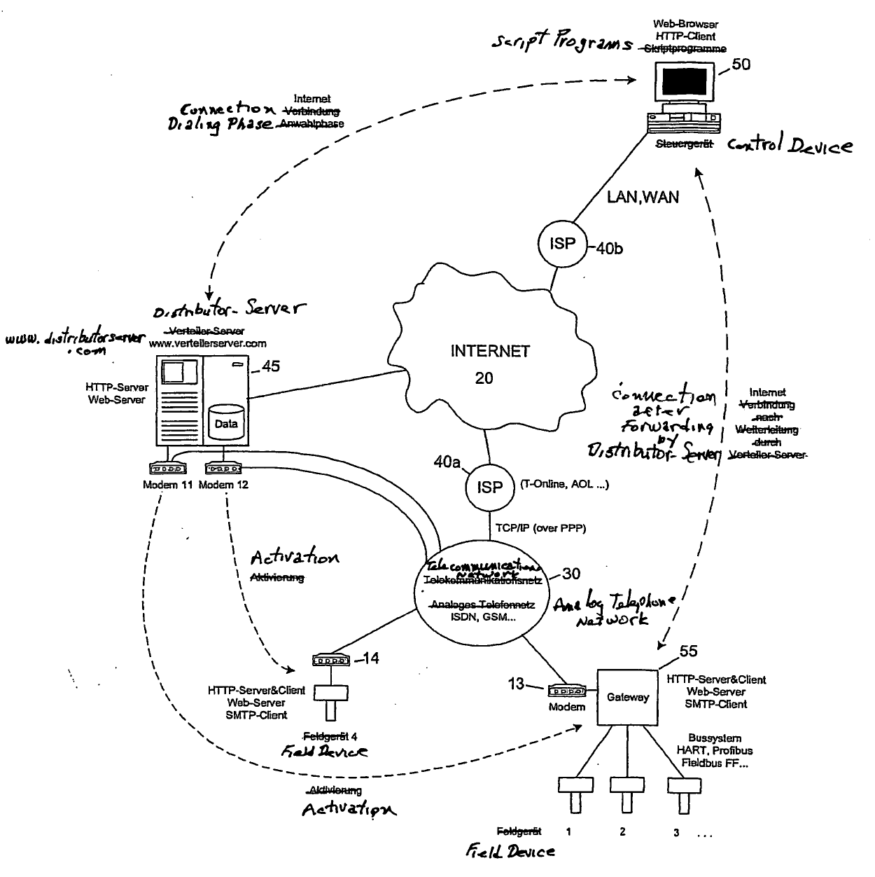

FIG. 1 shows a plurality of field devices 1,2,3,4 connected with a Internet-Service-Provider 40a via a gateway 55 and modem 13, or a modem 14, and the public telephone network.

The Internet-Service-Provider 40a enables the connection to the Internet 20. A control device 50 is also connected to the Internet 20 through an Internet-Service-Provider 40b. The control device 50, e.g. a PC-based measurement collection system, allows communication with the current Internet protocols (TCP/IP and HTTP). The control device 50 can communicate with the field devices 1,2,3,4 over a HTTP-Client (e.g. a standard Web browser). Gateway 55 and field device 4 are able to communicate with the current Internet protocols (TCP/IP, HTTP, SMTP). Field device 4 and the gateway 55 each use a web-interface with an integrated web-server (e.g. HTTP-server). The field device 1-4 and the gateway 55 each have a permanent address over which they can be contacted.

Besides connecting the control device 50 via an Internet-Service-Provider 40b, a direct connection with the Internet 20 is also possible.

A distributor-server 45 is, on the one hand, directly connected with the Internet 20, and, additionally, connected via one or more modems (here 11, 12) with the public telephone network 30.

The configuration of the distributer-server 45 will now be explained in greater detail.

The user calls-up the page of the distributor-server 45 (www.distributorserver.com) from the control device 50 using a Web browser. An authentication and password query is a possible security mechanism. Using an input form, a new field device can be installed or an already-installed field device can be accessed and its configuration data changed. The configuration data include the telecommunications connect-number of the corresponding modem, the permanent address of field device, designation of an alternative access name for the field device, respectively gateway, possibly with branched structure for describing a measurement location (access e.g. via: www.distributorserver.com/mainmeasurement.cgi?Site=TankFarm111 &TankNo.14), the activating or deactivating of the periodic collection of the field device data for mirroring the data of the field device or the gateway in the distributor-server 45 and simulation of the device behavior in a query to the permanent IP-address by access to the stored device information, the query cycle of the device data needed for the mirroring, in time units (hours, minutes) and specification of the number of ring procedures until the field device 4, respectively the gateway 55, dials into the Internet 20.

The distributor-server 45 does not necessarily have to be configured over the Internet. It can also be configured directly by the administrator of the distributor-server 45.

The method of the invention will now be explained in greater detail on the basis of a field device query to a field device that is connected directly with a modem. A query to a field device that is connected through a gateway with a modem proceeds correspondingly.

A field device query to a permanent address of the field device is sent from the control device 50 to the distributor-server 45 via Internet. The field device query for collecting the main measurement of the field device 4 can read as follows: www.distributorserver.com/mainmeasurement.cgi? PA=11074EBB76, wherein the permanent address of the field device 4 corresponds to its HART-address, which reads 11074EBB76.

The distributor-server 45 then dials the modem 14. This dialing occurs after the distributor-server has searched its internal database for the permanent address 11074EBB76 and has determined the corresponding telecommunications connection number of the modem 14. The modem 14 next logs-in at the Internet-Service-Provider 40a and transfers the current IP-address to the distributor-server 45 e.g. via the call www.distributorserver.com/DynamicIP.cgi? PA=11074EBB76 & IP=168.33.127.11. The distributor-server 45 forwards the field device query to the current IP-address of the field device 4 by the call http://168.33.127.11/mainmeasurement.cgi? PA=11074EBB76.

The control device 50 is now directly connected with the field device 4.

In this way, the user can, in simple manner, contact the field device 4 from the control device 50 and, so, query data from the field device 4, respectively transfer data to the field device 4, without knowing the current IP-address of the field device 4.

In an alternative embodiment of the invention, the field device data are mirrored in the distributor-server 45. For this, the distributer-server 45 dials the modem 14 on a regular schedule, following which the field device dials into the Internet and reports its current IP-address to the distributer-server 45. Then the distributor-server can access the field device 4 over the Internet and intermediately store the current information of the field device 4.

In this embodiment, the user likewise only dials the permanent address of the field device 4 and can then retrieve the information of the field device 4 stored in the distributor-server 45. In this way, there are no delays caused by having to assemble the telephone connection.

Since the user needs the information only at certain times, it makes sense that the query to the distributer-server 45 can be configured by the user him-, her- or itself.

1-3. (canceled)

4. A method for data exchange between a field device, which is connected with the Internet over a modem and the public telephone network, and a control device, which is likewise connected with the Internet, comprising the steps of:
a) Sending a field device query, directed to a permanent address of the field device, from the control device to a distributor-server via the Internet;
b) dialing the modem from the distributor-server;
c) log-in of the modem at an Internet-Service-Provider and transmission of the current IP-address of the field device to the distributor-server; and
d) forwarding the field device query to the current IP-address of the field device.

5. The method as claimed in claim 4, wherein:
a plurality of field devices are connected over a gateway with the modem.

6. The method for data exchange between a field device, which is connected over a modem and the public telephone network with the Internet, and a control device, which is likewise connected with the Internet, comprising the steps of:
a) periodic collecting of the field device information of the field device by the distributor-server;
b) intermediately storing the field device information in the distributor-server; and
c) transmitting the field device information in the case of a field device query to the permanent address of the field device by the control device.
